(19) United States
(12) Patent Application Publication
(10) Pub. No.: US 2009/0311930 A1
(43) Pub. Date: Dec. 17, 2009

(54) Flexible knife resistant composite

(76) Inventors: Yunzhang Wang, Duncan, SC (US); Howell B. Eleazer, Chesnee, SC (US)

Correspondence Address: Legal Department (M-495), P.O. Box 1926, Spartanburg, SC, 29304, US

(21) Appl. No.: 12/157,666

(22) Filed: Jun. 12, 2008

(51) Int. Cl. B32B 27/04

(52) U.S. Cl. 442/134

(57) ABSTRACT

A flexible knife resistant composite incorporating a stack of at least five knife resistant textile layers, where each knife resistant textile layer comprises monoaxially drawn tape elements. The tape elements contain a base layer strain oriented olefin polymer with at least one covering layer of a heat fusible olefin polymer on the base layer and the covering layer is characterized by a softening temperature below that of the base layer. The tape elements within each layer are consolidated to one another by the covering layer and the tape elements of one layer are not consolidated to the tape elements of the adjacent layers.

### FIELD OF THE INVENTION

The present application is directed to flexible composites exhibiting knife resistant properties.

### BACKGROUND

Police, correctional officers, security personnel, and even private individuals have a growing need for protection from knife penetration threats as well as spike and ballistic threats, in a single protective garment.

Known materials that protect against knife threats typically have flexible metallic plates, metallic chain mails, or laminated, resinated, or coated fabrics. However, the flexible metallic components tend to increase the weight of vests and are difficult to be cut into irregular shapes to fit the body. Further, materials with laminated or resinated or coated fabrics are less satisfactory against knife stab.

It is an object of this invention to provide a flexible light weight structure that resists penetration by knife threats. It is a further object to provide a flexible light weight structure that resists penetration by ballistic, knives and spike-like threats.

### BRIEF SUMMARY OF THE INVENTION

The invention provides a flexible knife resistant composite comprising a stack of at least five knife resistant textile layers, wherein each knife resistant textile layer comprises monoaxially drawn tape elements, the tape elements comprising a base layer strain oriented olefin polymer with at least one covering layer of a heat fusible olefin polymer on the base layer, wherein the covering layer is characterized by a softening temperature below that of the base layer, wherein the tape elements within each layer are consolidated to one another by the covering layer, and wherein the tape elements of one layer are not consolidated to the tape elements of the adjacent layers.

The flexible knife resistant composite according to the invention can further comprise ballistic resistant materials and/or additional puncture resistant materials (e.g., chain mail, metal plating, or ceramic plating). The invention also provides a process for producing a flexible spike and knife resistant composite.

### BRIEF DESCRIPTION OF THE DRAWINGS

FIGS. 1 and 2 are schematic cross-sectional views of one embodiment of the flexible knife resistant composite according to the invention.

FIGS. 3 and 4 illustrate schematically cross-sections of different embodiments of the monoaxially drawn tape element.

FIGS. 5 and 6 are schematic cross-sectional views of another embodiment of the flexible knife resistant composite according to the invention.

FIG. 7 is a sectional view of a spike and knife resistant flexible composite according to the invention.

FIG. 8 is a sectional view of a flexible spike and knife resistant composite according to the invention containing a flexible ballistic resistant panel.

FIG. 9 is a perspective view of a personal protection device, specifically a vest, incorporating the flexible resistant composite of the invention.

FIGS. 10A and 10B show sectional views of knife resistant flexible composites according to the invention.

### DETAILED DESCRIPTION OF THE INVENTION

As utilized herein, the term “knife resistant” is generally used to refer to a material that provides protection against penetration of the material by edged blades such as knives and other knife-like weapons or objects. Thus, a “knife resistant” material can either prevent penetration of the material by such an object or can lessen the degree of penetration of such an object as compared to similar, non-knife resistant materials. As utilized herein, the term “spike resistant” is generally used to refer to a material that provides protection against penetration of the material by sharp-pointed weapons or objects, such as an ice pick. Thus, a “spike resistant” material can either prevent penetration of the material by such an object or can lessen the degree of penetration of such an object as compared to similar, non-spike resistant materials.

Preferably, a “knife resistant” material achieves a pass rating when tested against Level 1, edged blade class threats in accordance with National Institute of Justice (NIJ) Standard 0115.00 (2000), entitled “Stab Resistance of Personal Body Armor.” The term “knife resistant” can also refer to materials (e.g., a composite according to the invention) achieving a pass rating when tested against higher level threats (e.g., Level 2 or Level 3). Preferably, a “spike resistant” material achieves a pass rating when tested against Level 1, Spike class threats in accordance with National Institute of Justice (NIJ) Standard 0115.00 (2000), entitled “Stab Resistance of Personal Body Armor.” The term “spike resistant” can also refer to materials (e.g., a composite according to the invention) achieving a pass rating when tested against higher level threats (e.g., Level 2 or Level 3).

In certain possibly preferred embodiments, the invention can also be directed to spike, knife and ballistic resistant flexible composite. As utilized herein, the term “ballistic resistant” generally refers to a material that is resistant to penetration by ballistic projectiles. Thus, a “ballistic resistant” material can either prevent penetration of the material by a ballistic projectile or can lessen the degree of penetration of such ballistic projectiles as compared to similar, non-ballistic resistant materials. Preferably, a “ballistic resistant” material provides protection equivalent to Type I body armor when such material is tested in accordance with National Institute of Justice (NIJ) Standard 0101.04 (2000), entitled “Ballistic Resistance of Personal Body Armor.” The term “ballistic resistant” also refers to a material that achieves a pass rating when tested against Level 1 or higher (e.g., Level 2A, Level 2, Level 3A, or Level 3 or higher) ballistic threats in accordance with NIJ Standard 0101.04.

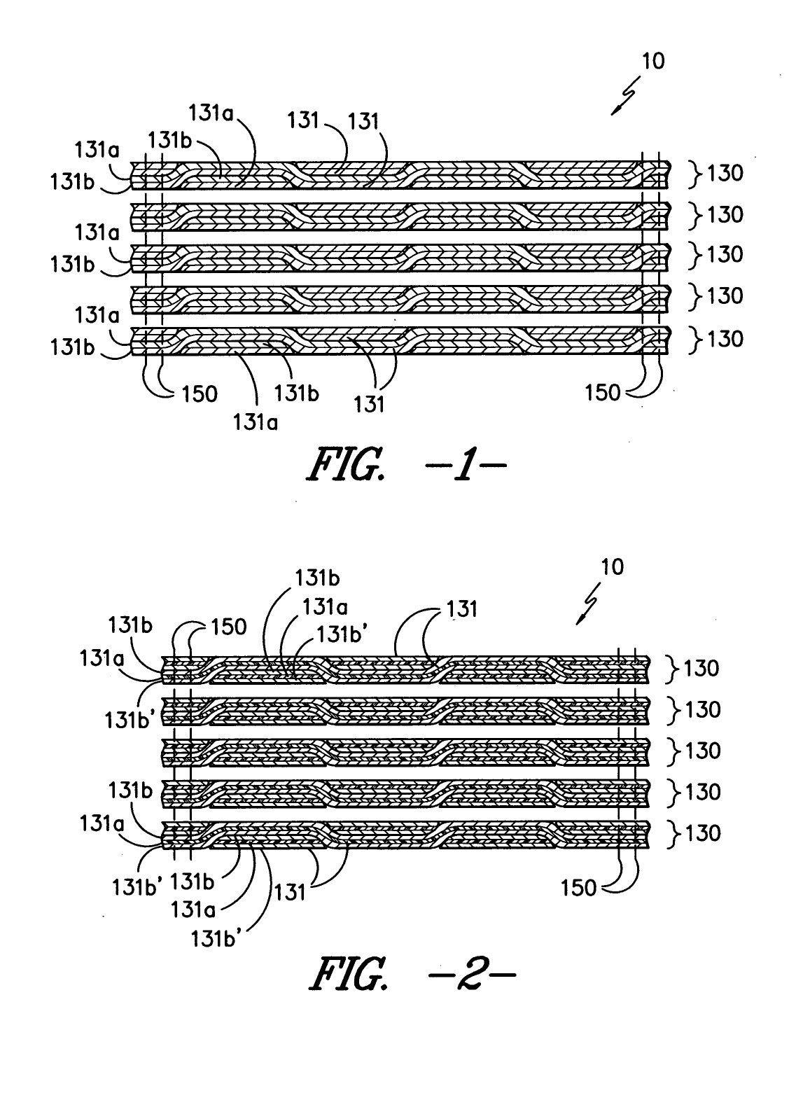

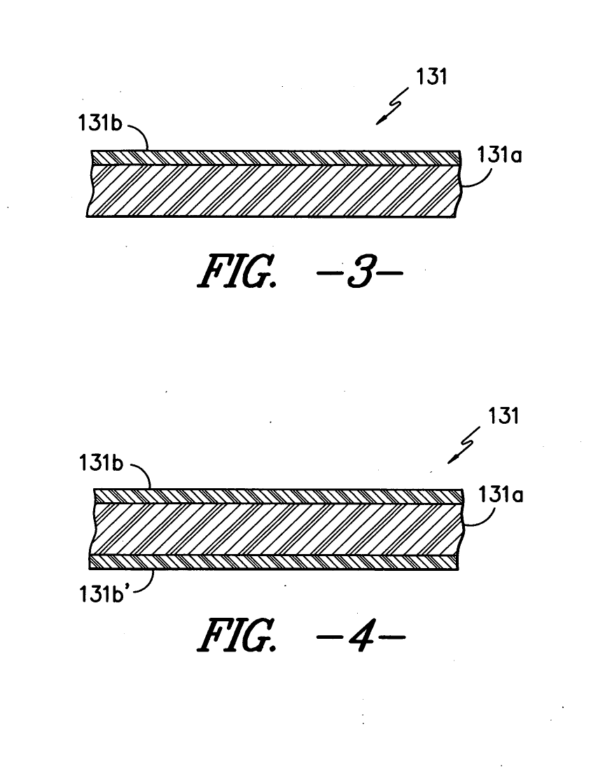

Referring to FIG. 1, the flexible knife resistant composite 10 contains a stack of five knife resistant textile layers 130. Each knife resistant textile layer 130 contains monoaxially drawn tape elements 131, the tape elements 131 comprising a base layer 131a being a strain oriented olefin polymer and one covering layer 131b of a heat fusible olefin polymer on the base layer 131a. The covering layer 131b is characterized by a softening temperature below that of the base layer 131a. The tape elements 131 within each layer 130 are consolidated to one another by the covering layer 131b, but the tape elements 131 of one layer 130 are not consolidated to the tape elements 131 of the adjacent layers 130. FIG. 2 shows another embodiment of the flexible knife resistant composite 10 where the tape elements 131 have a base layer 131a disposed between two covering layers 131b. The knife resistant textile layers 130 are either loosely stacked or attached by stitching 150 or other attachment means. While the flexible composite 10 has been depicted in FIG. 1 as including five knife layers 130, those of ordinary skill in the art will readily appreciate that the flexible composite 10 can comprise any suitable number of knife layers 130. For example, the flexible knife resistant composite 10 can comprise ten, twelve, eighteen, twenty, thirty, or forty knife layers. Preferably, the flexible knife resistant composite 10 has a knife resistance of at least Level 1 as tested according to NIJ Standard 01.15.00 (2000).

The flexible knife resistant composite 10 is able to be bent to a radius of about 4 cm without affecting its physical performance or breaking. Additionally, the knife layers 130 have a bending stiffness of between about 10 grams and 1000 grams as tested according to ASTM Test Method D6828-02, entitled “Standard Test Method for Stiffness of Fabric by Blade/Slot Procedure” for a 1 inch wide strip and 20 mm wide slot. More preferably, the knife layers 130 have a bending stiffness between about 10 and 50 grams.

While the knife resistant textile layer 130 is described as being knife resistant, the knife layer 130 may also have spike and/or ballistic resistant properties also. The knife resistant textile layer 130 contains monoaxially drawn tape elements 131. The tape elements have an aspect ratio of greater than 1, more preferably greater than 10, and have a size greater than 100 denier pre filament. Preferably, the tape elements 131 have a width of between about 0.1 and 20 mm, more preferably between about 0.5 and 5.0 mm. The tape elements 131 comprise a base layer 131a and at least one covering layer 131b (131b′) of a heat fusible polymer, the covering layer(s) 131b, 131b′ being characterized by a softening temperature below that of the base layer 131a to permit fusion bonding upon application of heat.

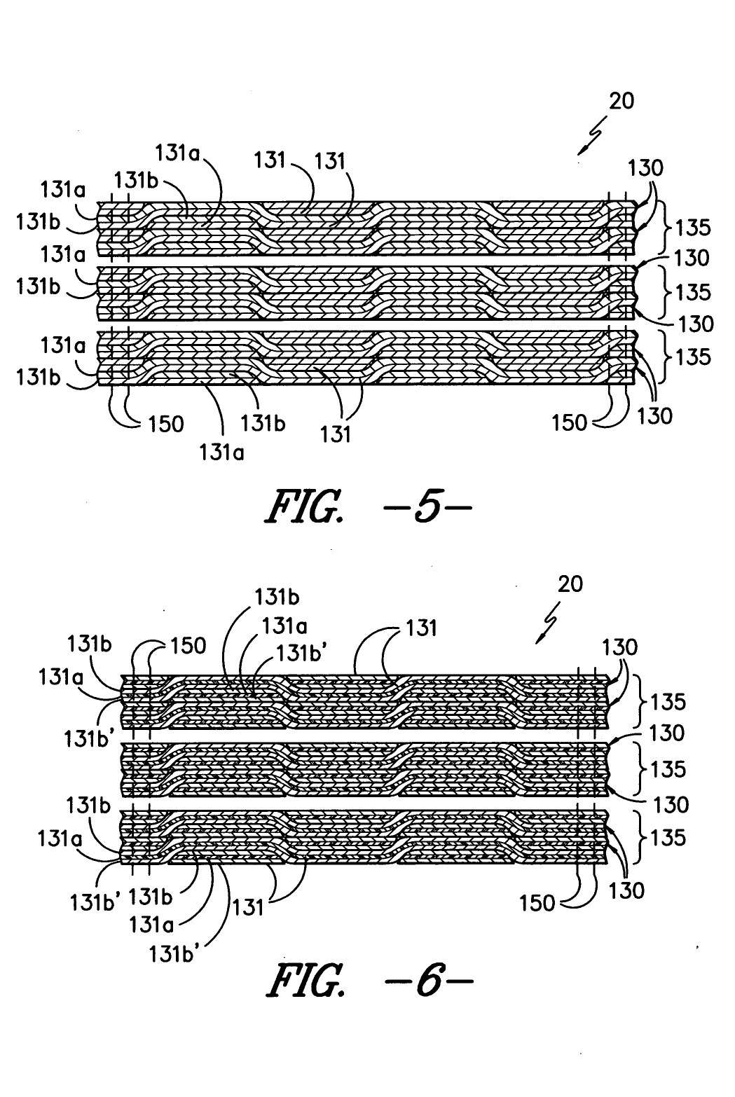

Referring to FIG. 3, the monoaxially drawn tape element 131 having one covering layer 131b disposed on a base layer 131a. The covering layer 131b covers one side (upper or lower surface) of the base layer 131a. FIG. 1 shows a flexible composite 10 with knife resistant textile layers 130 made of tape elements 131 having a base layer 131a and one covering layer 131b. Referring to FIG. 4, there is shown another embodiment of the tape elements 131 having a base layer 131a disposed between two covering layers 131b and 131b′ (the covering layers being disposed on the upper and lower surface of the base layer 131a). FIG. 2 shows a flexible composite 10 with knife resistant textile layers 130 made of tape elements 131 having a base layer 131a and two covering layers 131b, 131b′.

The tape element 131 may be formed by any conventional means of extruding multilayer polymeric films and then slitting the films into tape elements 131. By way of example, and not limitation, the film from which the tape elements 131 are formed may be formed by blown film or cast film extrusion or co-extrusion. The film is then cut into a multiplicity of longitudinal strips of a desired width by slitting the film in a direction transverse to the layered orientation of base layer 131a and covering layer(s) 131b (131b′) to form tape elements 131 with cross-sections as shown in FIGS. 3 and 4. The tape elements 131 are then drawn in order to increase the orientation of the base layer 131a so as to provide increased strength and stiffness of the material. In another embodiment, the covering layer(s) 131b (131b′) may be added after the drawing step in any suitable technique known-in the art including coating, spraying, and printing. After the drawing process is complete, the resulting tape elements being tape elements are in the range of about 1.0 to about 5 millimeters wide. In one embodiment, the tape elements 131 have a width to thickness ratio of between about 10 and 1000.

The base layer 131a of the tape elements 131 is preferably made up of a molecularly-oriented thermoplastic polymer, the base layer 131a being fusible and compatibly bonded to each of covering layers 131b, 131b′ at their respective intersections and contiguous surfaces. It is further contemplated that the covering layer(s) 131b, 131b′ have a softening temperature, or melting temperature, lower than that of the base layer 131a. By way of example only, it is contemplated that the base layer 131a is a polyolefin polymer such as polypropylene, polyethylene, polyester such as polyethylene terephthalate, or polyamide such as Nylon 6 or Nylon 6,6 (polyester and polyurethane are common base layer materials with low-melt polyester, polypropylene or polyethylene covering layers). The preferred covering layer 131b materials for this invention are polyolefin in nature where a highly drawn and therefore highly oriented polypropylene or polyethylene has a lower softening point polyolefin covering layer(s) commonly comprised of homopolymers or copolymers of ethylene, propylene, butene, 4-methyl-1-pentene, and/or like monomers. According to one potentially preferred practice, the base layer 131a may be polypropylene or polyethylene. The base layer 131a may account for about 50-99 wt. % of the tape or tape element, while the covering layer(s) 131b, 131b′ account for about 1-50 wt. % of the tape element 131. The base layer 131a and covering layer(s) 131b, 131b′ being made up of the same class of materials to provide an advantage with regard to recycling, as the base layer 131a may include, production scrap.

In an embodiment where the base layer 131a is polypropylene, the material of covering layer(s) 131b, and 131b′ is preferably a copolymer of propylene and ethylene or an α-olefin. In one embodiment, the covering layer(s) 131b, 131b′ comprise a random copolymer of propylene-ethylene with an ethylene content of about 1-25 mol. %, and a propylene content of about 75-99 mol. %. It may be further preferred to use said copolymer with a ratio of about 95 mol. % propylene to about 5 mol. % ethylene. Instead of said copolymer or in combination therewith, a polyolefin, preferably a polypropylene homopolymer or polypropylene copolymer, prepared with a metallocene catalyst, may be used for the covering layer(s) 131b, 131b′. It is also contemplated that materials such as poly(4-methyl-1-pentene) (PMP) and polyethylene may be useful as a blend with such copolymers in the covering layer(s) 131b, 131b′. The covering layer material should be selected such that the softening point of the covering layer(s) 131b, 131b′ is at least about 10° C. lower than that of the base layer 131a, and preferably between about 15-40° C. lower. The upper limit of this difference is not thought to be critical, and the difference in softening points is typically less than 70° C. Softening point, for this application, is defined as the Vicat softening temperature (ASTM D1525). It is desirable to minimize the amount of adhesive used to maximize the amount of tape elements in a composite.

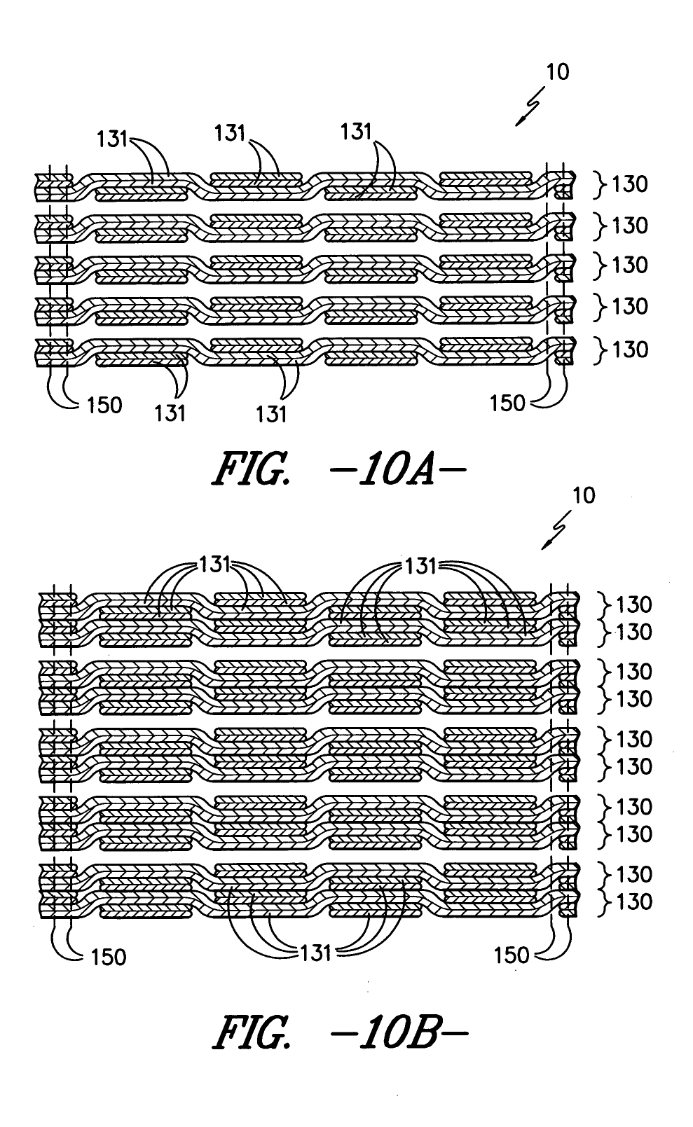

The knife resistant textile layer 130 can have the tape elements 131 in any suitable construction including but not limited to woven, knit, nonwoven or unidirectional. One knife resistant textile layer 130 is defined to have a set of tape elements in one direction and a set of tape elements in approximately perpendicular arrangement to the first set. One layer of woven or knit fabric satisfies this definition. For a unidirectional layer, a set of tape elements in the two perpendicular directions is defined as one layer. The unidirectional sheet is formed from a multiplicity of tape elements 131 are aligned parallel along a common tape direction. In one embodiment, the tape elements 131 in the textile layer 130 do not overlap one another, and may have gaps between the tape elements 131. In another embodiment, the tape elements overlap one another up to 90% in the textile layer 130. For a nonwoven layer, the layer contains tape elements at random angles to one another. In particularly preferred embodiment, the tape elements 131 in the knife resistant textile layer 130 are in a woven construction. While the Figures show the knife layers being formed from woven tape elements 131, each of the constructions shown may also be made with any other suitable construction. In one embodiment, two tape elements may be used together as the warp yarn and/or two tape elements may be used together as the weft yarn. This is shown in FIGS. 10A and 10B. For simplicity, the covering layers and base layers in the tape elements 131 were not shown. This configuration creates a knife layer having good weight and knife resistance when consolidated.

For the embodiment where the knife resistant textile layers 130 are in a woven construction, the woven layer preferably includes a multiplicity of warp and weft elements interwoven together such that a given weft element extends in a predefined crossing pattern above and below the warp element. In the illustrated arrangement, the warp and weft elements are formed into a so called plain weave wherein each weft element passes over a warp element and thereafter passes under the adjacent warp element in a repeating manner across the full width of the textile layer 130. However, it is also contemplated that any number of other weave constructions as will be well known to those of skill in the art may likewise be utilized. Thus, the terms “woven” and “interwoven” are meant to include any construction incorporating interengaging formation tape elements 131.

Tape elements and their textile layer constructions are believed to be more fully described in U.S. Patent Publication No. 2007/0071960 (Eleazer et al.), U.S. patent application Ser. No. 11/519,134 (Eleazer et al.), and U.S. Pat. Nos. 7,300,691 (Eleazer et al.), 7,294,383 (Eleazer et al.), and 7,294,384 (Eleazer et al.), each of which is incorporated by reference.

While not being bound by any theory, it is believed that when the tape elements are subjected to heat and pressure the outer covering layers of the tape elements consolidate or adhere together such that when cooled, each of the cross-over points in the layer are adhered together. This creates local areas of stiffness for the knife to cut through while maintaining flexibility in the fabric layer. It is believed that this interaction causes the increase in knife resistance as compared to unconsolidated sheets of tape elements.

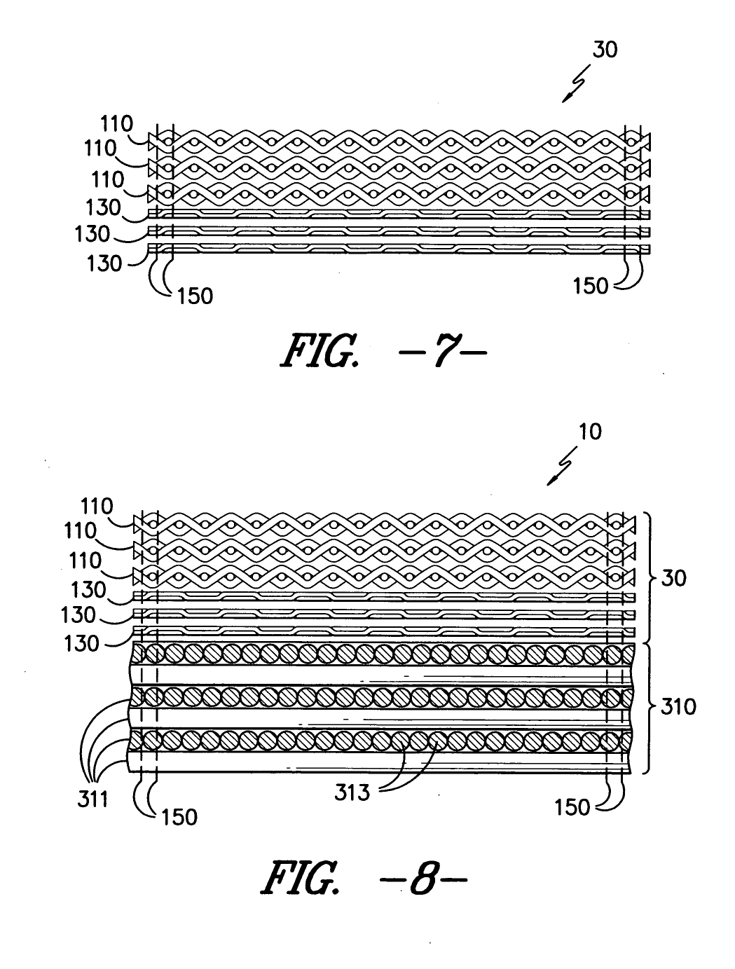

Referring now to FIG. 5, there is shown a flexible knife resistant composite 20 having three consolidated layer groupings 135, where each consolidated layer grouping 135 contains two knife resistant textile layers 130. The knife resistant textile layers 130 contain tape elements 131 that are consolidated to the other tape elements 131 within the consolidated layer grouping 135, but are not consolidated to the tape elements 131 of other consolidated layer groupings 135. Each layer grouping is consolidated using heat and pressure. In FIG. 5, the tape elements have a base layer 131a and one covering layer 131b. FIG. 6 shows the same configuration of layers, but the tape elements 131 have a base layer 131a disposed between two covering layers 131b and 131b′. This “doublet” configuration of two consolidated knife resistant textile layers 130 together to form a consolidated grouping 135 creates a composite with more knife penetration resistance compared to single consolidated sheets (at the same areal density), but has less flexibility. Having two layers of the tape elements together, when consolidated provides even more localized stiffness in the cross-over points in the “doublet” configuration. In one embodiment, in the flexible knife resistant composite 10, there is a combination of single consolidated knife layers and doublet consolidated knife layers.

While the flexible composite 20 has been depicted in FIG. 7 as including three consolidated layer groupings 135, those of ordinary skill in the art will readily appreciate that the flexible composite 20 can comprise any suitable number of layer groupings 135. For example, the flexible knife resistant composite 20 can comprise six, ten, twelve, eighteen, twenty, thirty, or forty layer groupings 135. Preferably, the flexible knife resistant composite 20 has a knife resistance of at least Level 1 as tested according to NIJ Standard 0115.00 (2000). In one embodiment, the flexible composite 20 can contain both consolidated layer groupings 135 (two knife layers consolidated together) and single consolidated knife resistant layers 130.

The flexible knife resistant composite 20 is able to be bent to a radius of about 4 cm without affecting its physical performance or breaking. Additionally, the layer groupings 135 have a bending stiffness of between about 10 grams and 1000 grams as tested according to ASTM Test Method D6828-02, entitled “Standard Test Method for Stiffness of Fabric by Blade/Slot Procedure” for a 1 inch wide strip and 20 mm wide slot. More preferably, the layer groupings 130 have a bending stiffness between about 10 and 500 grams with a normalized stiffness of between about 0.1 and 5 g/g/m².

Referring now to FIG. 7, there is shown a flexible spike and knife resistant composite 30 containing three spike resistant textile layers 110 and three knife resistant layers 130. The spike resistant textile layers 110 contain a plurality of interlocking yarns or fibers having a tenacity of about 8 or more grams per denier. The knife resistant textile layers 130 contain consolidated monoaxially drawn tape elements 131, the tape elements 131 comprising a base layer 131a and at least one covering layer 131b of a heat fusible polymer, and where the tape elements 131 within each layer are adhered to one another by the covering layer 131b. The spike resistant textile layers 110 and the knife resistant textile layers 130 are loosely stacked or attached by stitching 150 or other attachment means, but are not consolidated to one another. While the flexible composite 30 has been depicted in FIG. 9 as including three spike resistant textile layers 110 and three knife resistant layers 130 those of ordinary skill in the art will readily appreciate that the flexible composite 10 can comprise any suitable number of layers 110 and 130. For example, the spike and knife resistant flexible composite 10 can comprise four spike resistant textile layers 110 and four knife resistant layers 130 or ten spike resistant textile layers 110 and three knife resistant layers 130, etc. The composite 10 may have the same number of spike layers as knife layers or they may differ. In one embodiment, the composite 10 contains at least ten spike resistant textile layers 110 and at least ten knife resistant layers 130. In another embodiment, the composite 10 contains at least twenty spike resistant textile layers 110 and at least twenty knife resistant layers 130. While depicted in FIG. 7 is a preferred embodiment where the spike resistant textile layers 110 are grouped together and the knife resistant textile layers 130 are grouped together, they may be mixed together or randomly oriented within the composite 30.

While the spike resistant textile layer 110 is described as being spike resistant, the spike resistant textile layer 110 may also have knife and/or ballistic resistant properties. The spike resistant textile layer 110 contains a plurality of interlocking yarns or fibers 110 having a tenacity of about 8 or more grams per denier. In a preferred embodiment, the plurality of yarns or fibers 110 have a tenacity of about 10 or more grams per denier and have a size of less than ten denier per filament, more preferably less than 5 denier per filament. In another preferred embodiment, the plurality of yarns or fibers 110 has a tenacity of about 15 or more grams per denier. The spike resistant textile layer 110 can have any suitable construction. For example, the spike resistant textile layer 110 can comprise a plurality of yarns provided in a knit, woven, or suitable nonwoven construction. The spike layer 110 construction resists slippage of the fibers or yarns past one another.

As will be understood by those of ordinary skill in the art, the spike resistant textile layers 110 in the flexible composite 10 can be independently provided in each of the aforementioned suitable constructions. For example, a number of spike resistant textile layers 110 can comprise a plurality of yarns 111 provided in a woven construction and a number of spike resistant textile layers 110 can comprise a plurality of fibers 111 provided in a knit construction. The spike resistant textile layers 110 can have any suitable weight. In certain possibly preferred embodiments, the spike resistant textile layers 110 can have a weight of about 2 to about 10 ounces per square yard.

The spike resistance layer has a tightness of between greater than about 0.75 as defined in U.S. Pat. Nos. 6,133,169 (Chiou) and 6,103,646 (Chiou), which are incorporated herein by reference. “Fabric tightness factor” and “Cover factor” are names given to the density of the weave of a fabric. Cover factor is a calculated value relating to the geometry of the weave and indicating the percentage of the gross surface area of a fabric that is covered by yarns of the fabric. The equation used to calculate cover factor is as follows (from Weaving: Conversion of Yarns to Fabric, Lord and Mohamed, published by Merrow (1982), pages 141-143):
d_{w}=width of warp yarn in the fabric
d_{f}=width of fill yarn in the fabric
p_{w}=pitch of warp yarns (ends per unit length)
p_{f}=pitch of fill yarns

$${C}_{w} = \frac{{d}_{w}}{{p}_{w}} {C}_{f} = \frac{{d}_{f}}{{p}_{f}}$$

$$Fabric\_Cover \_Factor = Cfab = \frac{total\_area \_obsured}{area\_enclosed}$$

$${C}_{fab} = \frac{( {p}_{w} - {d}_{w} ) {d}_{f} + {d}_{w} {p}_{f}}{{p}_{w} {p}_{f}}$$

$${C}_{fab} = ( {C}_{f} + {C}_{w} - {C}_{f} {C}_{w} )$$

Depending on the kind of weave of a fabric, the maximum cover factor may be quite low even though the yarns of the fabric are situated close together. For that reason, a more useful indicator of weave tightness is called the “fabric tightness factor”. The fabric tightness factor is a measure of the tightness of a fabric weave compared with the maximum weave tightness as a function of the cover factor.

$$Fabric\_tightness \_factor = \frac{actual\_cover \_factor}{maximum\_cover \_factor}$$

For example, the maximum cover factor that is possible for a plain weave fabric is 0.75; and a plain weave fabric with an actual cover factor of 0.68 will, therefore, have a fabric tightness factor of 0.91. The preferred weave for practice of this invention is plain weave.

The yarns or fibers 111 of the spike resistant textile layers 110 can comprise any suitable fibers. Yarns or fibers 111 suitable for use in the spike resistant textile layer 110 generally include, but are not limited to, high tenacity and high modulus yarns or fibers, which refers to yarns that exhibit a relatively high ratio of stress to strain when placed under tension. In order to provide adequate protection against ballistic projectiles, the yarns or fibers of the spike resistant textile layers 110 typically have a tenacity of about 8 or more grams per denier. In certain possibly preferred embodiments, the yarns or fibers of the spike resistant textile layers 110 can have a tenacity of about 10 or more grams per denier, more preferably 15 or more grams per denier.

Fibers or yarns 111 suitable for use in the spike resistant textile layers 110 include, but are not limited to, fibers made from highly oriented polymers, such as gel-spun ultrahigh molecular weight polyethylene fibers (e.g., SPECTRA® fibers from Honeywell Advanced Fibers of Morristown, N.J. and DYNEEMA® fibers from DSM High Performance Fibers Co. of the Netherlands), melt-spun polyethylene fibers (e.g., CERTRAN® fibers from Celanese Fibers of Charlotte, N.C.), melt-spun nylon fibers (e.g., high tenacity type nylon 6,6 fibers from Invista of Wichita, Kans.), melt-spun polyester fibers (e.g., high tenacity type polyethylene terephthalate fibers from Invista of Wichita, Kans.), and sintered polyethylene fibers (e.g., TENSYLON® fibers from ITS of Charlotte, N.C.). Suitable fibers also include those made from rigid-rod polymers, such as lyotropic rigid-rod polymers, heterocyclic rigid-rod polymers, and thermotropic liquid-crystalline polymers. Suitable fibers made from lyotropic rigid-rod polymers include aramid fibers, such as poly(p-phenyleneterephthalamide) fibers (e.g., KEVLAR® fibers from DuPont of Wilmington, Del. and TWARON® fibers from Teijin of Japan) and fibers made from a 1:1 copolyterephthalamide of 3,4′-diaminodiphenylether and p-phenylenediamine (e.g., TECHNORA® fibers from Teijin of Japan). Suitable fibers made from heterocyclic rigid-rod polymers, such as p-phenylene heterocyclics, include poly(p-phenylene-2,6-benzobisoxazole) fibers (PBO fibers) (e.g., ZYLON® fibers from Toyobo of Japan), poly(p-phenylene-2,6-benzobisthiazole) fibers (PBZT fibers), and poly[2,6-diimidazo[4,5-b:4′,5′-e]pyridinylene-1,4-(2,5-dihydroxy)phenylene] fibers (PIPD fibers) (e.g., M5 fibers from DuPont of Wilmington, Del.). Suitable fibers made from thermotropic liquid-crystalline polymers include poly(6-hydroxy-2-napthoic acid-co-4-hydroxybenzoic acid) fibers (e.g., VECTRAN® fibers from Celanese of Charlotte, N.C.). Suitable fibers also include carbon fibers, such as those made from the high temperature pyrolysis of rayon, polyacrylonitrile (e.g., OPF® fibers from Dow of Midland, Mich.), and mesomorphic hydrocarbon tar (e.g., THORNEL® fibers from Cytec of Greenville, S.C.). In certain possibly preferred embodiments, the yarns or fibers 111 of the spike resistant textile layers 110 comprise fibers selected from the group consisting of gel-spun ultrahigh molecular weight polyethylene fibers, melt-spun polyethylene fibers, melt-spun nylon fibers, melt-spun polyester fibers, sintered polyethylene fibers, aramid fibers, PBO fibers, PBZT fibers, PIPD fibers, poly(6-hydroxy-2-napthoic acid-co-4-hydroxybenzoic acid) fibers, carbon fibers, and combinations thereof. In one particularly preferred embodiment, the spike resistant textile layer 110 comprises woven aramid fibers 111.

In one embodiment, the spike resistant textile layer 110 comprises a coating 113 on at least a surface thereof. In certain possibly preferred embodiments, the coating can penetrate into the interior portion of the textile layer 110 to at least partially coat the yarns or fibers 111 of the spike resistant textile layer 110. In another embodiment, the coating 113 is applied to either surface of the spike resistant textile layer 110. The coating 113 may be applied to the surfaces of the spike resistant textile layers 110 which are not adjacent to a surface of another layer or may be applied such that the coating 113 lies between two adjacent layers.

The coating 113 applied to the spike resistant textile layers 110 comprises particulate matter (e.g., a plurality of particles). The particles included in the coating 113 can be any suitable particles, but preferably are particles having a diameter of about 20 μm or less, or about 10 μm or less, or about 1 μm or less (e.g., about 500 nm or less or about 300 nm or less). Particles suitable for use in the coating include, but are not limited to, silica particles, (e.g., fumed silica particles, precipitated silica particles, alumina-modified colloidal silica particles, etc.), alumina particles (e.g. fumed alumina particles), and combinations thereof. In certain possibly preferred embodiments, the particles are comprised of at least one material selected from the group consisting of fumed silica, precipitated silica, fumed alumina, alumina modified silica, zirconia, titania, silicon carbide, titanium carbide, tungsten carbide, titanium nitride, silicon nitride, and the like, and combinations thereof. Such particles can also be surface modified, for instance by grafting, to change surface properties such as charge and hydrophobicity. Suitable commercially available particles include, but are not limited to, the following: CAB-O-SPERSE® PG003 fumed alumina, which is a 40% by weight solids aqueous dispersion of fumed alumina available commercially from Cabot Corporation of Boyertown, Pa. (the dispersion has a pH of 4.2 and a median average aggregate particle size of about 150 nm); SPECTRAL™ 51 fumed alumina, which is a fumed alumina powder available commercially from Cabot Corporation of Boyertown, Pa. (the powder has a BET surface area of 55 m²/g and a median average aggregate particle size of about 150 nm); CAB-O-SPERSE® PG008 fumed alumina, which is a 40% by weight solids aqueous dispersion of fumed alumina available commercially from Cabot Corporation of Boyertown, Pa. (the dispersion has a pH of 4.2 and a median average aggregate particle size of about 130 nm); SPECTRAL™ 81 fumed alumina, which is a fumed alumina powder available commercially from Cabot Corporation of Boyertown, Pa. (the powder has a BET surface area of 80 m²/g and a median average aggregate particle size of about 130 nm); AEROXIDE ALU C fumed alumina, which is a fumed alumina powder available commercially from Degussa, Germany (the powder has a BET surface area of 100 m²/g and a median average primary particle size of about 13 nm); LUDOX® CL-P colloidal alumina coated silica, which is a 40% by weight solids aqueous sol available from Grace Davison (the sol has a pH of 4 and an average particle size of 22 nm in diameter); NALCO® 1056 aluminized silica, which is a 30% by weight solids aqueous colloidal suspension of aluminized silica particles (26% silica and 4% alumina) available commercially from Nalco; LUDOX® TMA colloidal silica, which is a 34% by weight solids aqueous colloidal silica sol available from Grace Davison. (the sol has a pH of 4.7 and an average particle size of 22 nm in diameter); NALCO® 88SN-126 colloidal titanium dioxide, which is a 10% by weight solids aqueous dispersion of titanium dioxide available commercially from Nalco; CAB-O-SPERSE® S3295 fumed silica, which is a 15% by weight solids aqueous dispersion of fumed silica available commercially from Cabot Corporation of Boyertown, Pa. (the dispersion has a pH of 9.5 and an average agglomerated primary particle size of about 100 nm in diameter); CAB-O-SPERSE® 2012A fumed silica, which is a 12% by weight solids aqueous dispersion of fumed silica available commercially from Cabot Corporation of Boyertown, Pa. (the dispersion has a pH of 5); CAB-O-SPERSE® PG001 fumed silica, which is a 30% by weight solids aqueous dispersion of fumed silica available commercially from Cabot Corporation of Boyertown, Pa. (the dispersion has a pH of 10.2 and a median aggregate particle size of about 180 nm in diameter); CAB-O-SPERSE® PG002 fumed silica, which is a 20% by weight solids aqueous dispersion of fumed silica available commercially from Cabot Corporation of Boyertown, Pa. (the dispersion has a pH of 9.2 and a median aggregate particle size of about 150 nm in diameter); CAB-O-SPERSE® PG022 fumed silica, which is a 20% by weight solids aqueous dispersion of fumed silica available commercially from Cabot Corporation of Boyertown, Pa. (the dispersion has a pH of 3.8 and a median aggregate particle size of about 150 nm in diameter); SIPERNAT® 22LS precipitated silica, which is a precipitated silica powder available from Degussa of Germany (the powder has a BET surface area of 175 m²/g and a median average primary particle size of about 3 μm); SIPERNAT® 500LS precipitated silica, which is a precipitated silica powder available from Degussa of Germany (the powder has a BET surface area of 450 m²/g and a median average primary particle size of about 4.5 μm); and VP Zirconium Oxide fumed zirconia, which is a fumed zirconia powder available from Degussa of Germany (the powder has a BET surface area of 60 m²/g).

In certain possibly preferred embodiments, the particles can have a positive surface charge when suspended in an aqueous medium, such as an aqueous medium having a pH of about 4 to 8. Particles suitable for use in this embodiment include, but are not limited to, alumina-modified colloidal silica particles, alumina particles (e.g. fumed alumina particles), and combinations thereof. In certain possibly preferred embodiments, the particles can have a Mohs' hardness of about 5 or more, or about 6 or more, or about 7 or more. Particles suitable for use in this embodiment include, but are not limited to, fumed alumina particles. In certain possibly preferred embodiments, the particles can have a three-dimensional branched or chain-like structure comprising or consisting of aggregates of primary particles. Particles suitable for use in this embodiment include, but are not limited to, fumed alumina particles, fumed silica particles, and combinations thereof.

The particles included in the coating can be modified to impart or increase the hydrophobicity of the particles. For example, in those embodiments comprising fumed silica particles, the fumed silica particles can be treated, for example, with an organosilane in order to render the fumed silica particles hydrophobic. Suitable commercially-available hydrophobic particles include, but are not limited to, the R-series of AEROSIL® fumed silicas available from Degussa, such as AEROSIL® R812, AEROSIL® R816, AEROSIL® R972, and AEROSIL® R7200. While not wishing to be bound to any particular theory, it is believed that using hydrophobic particles in the coating will minimize the amount of water that the composite will absorb when exposed to a wet environment. When hydrophobic particles are utilized in the coating on the textile layer(s) 110, the hydrophobic particles can be applied using a solvent-containing coating composition in order to assist their application. Such particles and coatings are believed to be more fully described in U.S. Patent Publication No. 2007/0105471 (Wang et al.), incorporated herein by reference.

The spike resistant textile layer(s) 110 can comprise any suitable amount of the coating 113. As will be understood by those of ordinary skill in the art, the amount of coating applied to the spike resistant textile layer(s) 110 generally should not be so high that the weight of the composite 10 is dramatically increased, which could potentially impair certain end uses for the composite 10. Typically, the amount of coating 113 applied to the spike resistant textile layer(s) 110 will comprise about 10 wt. % or less of the total weight of the textile layer 110. In certain possibly preferred embodiments, the amount of coating applied to the spike resistant textile layer(s) 110 will comprise about 5 wt. % or less or about 3 wt. % or less (e.g., about 2 wt. % or less) of the total weight of the textile layer 110. Typically, the amount of coating applied to the spike resistant textile layer(s) 110 will comprise about 0.1 wt. % or more (e.g., about 0.5 wt. % or more) of the total weight of the textile layer 110. In certain possibly preferred embodiments, the coating comprises about 2 to about 4 wt. % of the total weight of the textile layer 110.

In certain possibly preferred embodiments of the flexible spike and knife resistant composite 10, the coating 113 applied to the spike resistant textile layer 110 can further comprise a binder. The binder included, in the coating 113 can be any suitable binder. Suitable binders include, but are not limited to, isocyanate binders (e.g., blocked isocyanate binders), acrylic binders (e.g., nonionic acrylic binders), polyurethane binders (e.g., aliphatic polyurethane binders and polyether based polyurethane binders), epoxy binders, and combinations thereof. In certain possibly preferred embodiments, the binder is a cross-linking binder, such as a blocked isocyanate binder.

When present, the binder can comprise any suitable amount of the coating applied to the spike resistant textile layer(s) 110. The ratio of the amount (e.g., weight) of particles present in the coating to the amount (e.g., weight) of binder solids present in the coating 113 typically is greater than about 1:1 (weight particles:weight binder solids). In certain possibly preferred embodiments, the ratio of the amount (e.g., weight) of particles present in the coating 113 to the amount (e.g., weight) of binder solids present in the coating typically is greater than about 2:1, or greater than about 3:1, or greater than about 4:1, or greater than about 5:1 (e.g., greater than about 6:1, greater than about 7:1, or greater than about 8:1).

In certain possibly preferred embodiments, the coating 113 applied to the spike resistant textile layer(s) 110 can comprise a water-repellant in order to impart greater water repellency to the composite 10. The water-repellant included in the coating can be any suitable water-repellant including, but not limited to, fluorochemicals or fluoropolymers.

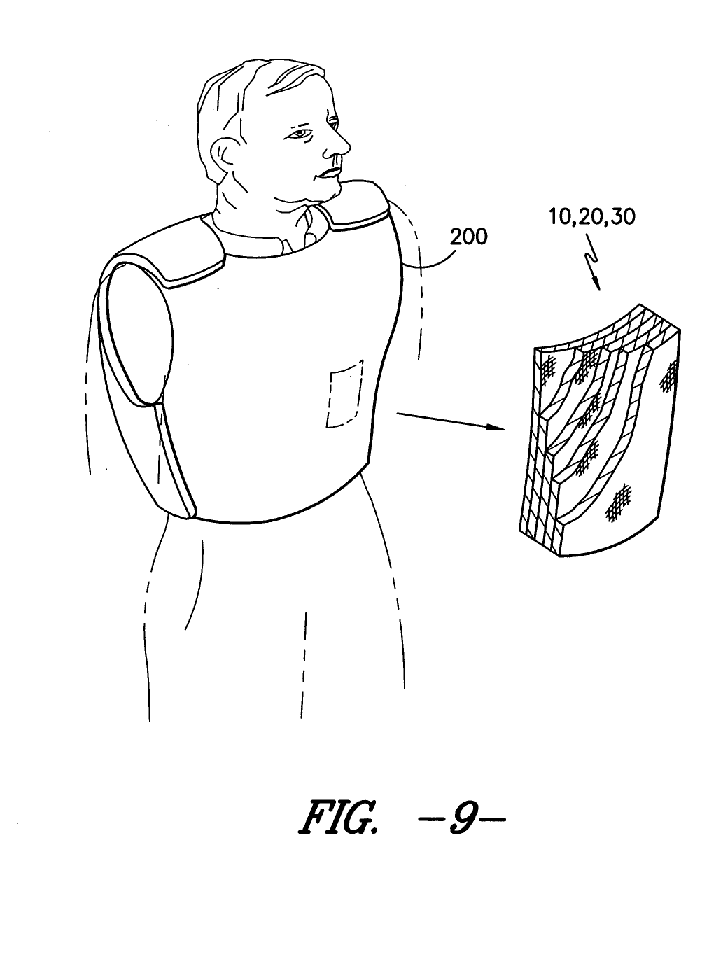

Additional layers may be added to the composites 10, 20, 30 to add additional spike, knife, and/or ballistic resistance or other desired properties. In one embodiment, the flexible composite comprises a flexible ballistic panel as shown in FIG. 8.

An example of a known ballistic resistant material suitable for use in the composites 10, 20, 30 of the invention is the flexible ballistic resistant panel 310 depicted in FIG. 8. In one embodiment, the flexible ballistic resistant panel 310 comprises multiple layers 311 of substantially parallel fibers 313. The fibers 313 suitable for use in the layers 311 can be any of the fibers discussed above as being suitable for use in the textile layers 110, 130 of the composite 10, 20, 30 of the invention, including any suitable combinations of such fibers. While the fibers 313 in layers 311 in FIG. 8 are unidirectional, the fibers 313 may be unidirectional or other nonwoven constructions, woven, or knit. The multiple layers 311 may also include a binder. While the flexible ballistic resistant panel 310 depicted in FIG. 8 is shown with the fibers 313 within layers 311 disposed at an angle of about 90 degrees relative to the fibers 313 of adjacent layers 311, the fibers 311 can be disposed at any suitable angle between 0 and 180 degrees relative to each other.

Commercially-available, flexible ballistic resistant panels such as those described above include, but are not limited to, the SPECTRA SHIELD® high-performance ballistic materials sold by Honeywell International Inc. Such ballistic resistant laminates are believed to be more fully described in U.S. Pat. Nos. 4,916,000 (Li et al.); 5,437,905 (Park); 5,443,882 (Park); 5,443,883 (Park); and 5,547,536 (Park), each of which is herein incorporated by reference. Other commercially available high performance flexible ballistic resistant materials include DYNEEMA UD® available from DSM Dymeema, and GOLDFLEx® available from Honeywell International Inc. These high performance flexible ballistic materials may be used together with the flexible spike and knife resistant composite 10 to enhance overall ballistic performance.

Additional layers may be added to the flexible spike and knife resistant composite 10 to add additional spike and knife resistance. Examples of suitable known puncture resistant materials or components include, but are not limited to, mail (e.g., chain mail), metal plating, ceramic plating, layers of textile materials made from high tenacity yarns which layers have been impregnated or laminated with an adhesive or resin, or textile materials made from low denier high tenacity yarns in a tight woven form such as DuPont KEVLAR CORRECTIONAL® available from DuPont. Such spike and knife resistant materials or components can be attached to adjacent textiles layer using any suitable means, such as an adhesive, stitches, or other suitable mechanical fasteners, or the material or component and textile layers can be disposed adjacent to each other and held in place relative to each other by a suitable enclosure, such as a pocket in a piece of body armor which is adapted to carry a spike, knife, and/or ballistic resistant insert. The flexible spike and knife resistant composite 10 according to the invention can further comprise one or more layers of suitable backing material, such as a textile material (e.g., a textile material made from any suitable natural or synthetic fiber), foam, or one or more plastic sheets (e.g., polycarbonate sheets). For example, the backing material can comprise a plurality of layers of woven or knit polyester textile material which are positioned adjacent to the upper or lower surface of the above-described textile layers. The backing material can also be a trauma pack (e.g., one or more polycarbonate sheets), such as those typically used in body armor. In another embodiment, adhesive layers may be added.

The process to form the spike resistant layers 110 where the spike resistant layers 110 comprising a plurality of interwoven yarns or fibers having a tenacity of about 8 or more grams per denier, wherein at least one of the surfaces of the spike resistant textile layer comprises about 10 wt. % or less, based on the total weight of the textile layer, of a coating comprising a plurality of particles having a diameter of about 20 μm or less comprises the steps of

(a) providing a first textile layer,

(b) contacting at least one of the lower surface of the first textile layer with a coating composition comprising a plurality of particles having a diameter of about 20 μm or less, and

(c) drying the textile layer treated in step (b) to produce a coating on the lower surface of the first textile layer or the upper surface of the second textile layer.

The surface(s) of the textile layer(s) can be contacted with the coating composition in any suitable manner. The textile layers can be contacted with the coating composition using convention padding, spraying (wet or dry), foaming, printing, coating, and exhaustion techniques. For example, the textile layer(s) can be contacted with the coating composition using a padding technique in which the textile layer is immersed in the coating composition and then passed through a pair of nip rollers to remove any excess liquid. In such an embodiment, the nip rollers can be set at any suitable pressure, for example, at a pressure of about 280 kPa (40 psi). Alternatively, the surface of the textile layer to be coated can be first coated with a suitable adhesive, and then the particles can be applied to the adhesive.

The coated textile-layer(s) can be dried using any suitable technique at any suitable temperature. For example, the textile layer(s) can be dried on a conventional tenter frame or range at a temperature of about 160° C. (320° F.) for approximately five minutes. The form spike resistant textile layer comprises about 10 wt. % or less, based on the total weight of the textile layer, of a coating comprising a plurality of particles having a diameter of about 20 μm or less may be found in US Patent Publication 2007/0105471 (Wang et al.), incorporated herein by reference.

The process to form the forming the knife resistant textile layers comprising monoaxially drawn tape elements, the tape elements comprising a base layer and at least one covering layer of a heat fusible polymer, where the covering layer is characterized by a softening temperature below that of the base layer to permit fusion bonding upon application of heat is described in more detail in U.S. Patent Publication No. 2007/0071960 (Eleazer et al.), U.S. patent application Ser. No. 11/519,134 (Eleazer et al.), and U.S. Pat. Nos. 7,300,691 (Eleazer et al.), 7,294,383 (Eleazer et al.), and 7,294,384 (Eleazer et al.), each of which is incorporated by reference.

Consolidation of individual knife layers 130 or consolidated layer groupings (double knife layers) 135 are preferably carried out at suitable temperature and pressure conditions to facilitate both interface bonding fusion and partial migration of the softened or melted covering layer(s) 131b, and 131b′. Heated batch or platen presses may be used for multi-layer consolidation with release layers between the layers. However, it is contemplated that any other suitable press may likewise be used to provide appropriate combinations of temperature and pressure. According to a potentially preferred practice, heating is carried out at a temperature of about 130-160° C. and a pressure of about 0.5-70 bar. According to a potentially preferred practice, cooling is carried out under pressure to a temperature less than about 115° C. It is contemplated that maintaining pressure during the cooling step tends to inhibit shrinkage. Without wishing to be limited to a specific theory, it is believed that higher pressures may facilitate polymer flow at lower temperatures. Thus, at the higher end of the pressure range, (greater than about 20 bar) the processing temperature may be about 90-135° C. Moreover, the need for cooling under pressure may be reduced or eliminated when these lower temperatures are utilized. The temperature operating window to fuse the sheets is wide allowing for various levels of consolidation to occur thus achieving either a more structural panel or one that would delaminate more with impact.

The layers in the composites 10, 20, 30 can be disposed adjacent to each other and held in place relative to each other by a suitable enclosure, such as a pocket or can be attached to each other by any known fastening means 150. In certain possibly preferred embodiments the layers can also be sewn together in a desired pattern, for example, around the corners or along the perimeter of the stacked textile layers in order to secure the layers in the proper or desired arrangement. Additionally, the layers may be adhered together using a patterned adhesive or other fastening means such as rivets, bolts, wires, or clamps.

The flexible composites 10, 20, 30 of the invention are particularly well suited for use in personal protection devices, such as personal body armor. For example, as depicted in FIG. 9, the flexible composites 10, 20, 30 can be incorporated into a vest 200 in order to provide the wearer protection against spike, knife, and in certain embodiments ballistic threats.

### EXAMPLES

Various embodiments of the invention are shown by way of the Examples below, but the scope of the invention is not limited by the specific Examples provided herein.

### Test Methods

### Consolidated Layer Groupings Stiffness Test Method

The stiffness of the consolidated layer groupings was measured according to the modified ASTM Test Method D6828-02, entitled “Standard Test Method for Stiffness of Fabric by Blade/Slot Procedure”. The sample size used was 1 inch by 4 inch and the width of the slot was set to 20 mm. In order to minimize the effect due to surface friction, a thin Teflon sheet was inserted between the sample and the slot during measurements.

### Knife and Stab Resistance Test Method

The stacked consolidated layer groupings (The number of consolidated layer groupings was chosen such that the total areal density is approximately 6.40 kg/m²) were encased in a nylon bag and then tested for knife stab resistance according to NIJ Standard 0115.00 (2000), entitled “Stab Resistance of Personal Body Armor”. The stab energy of the drop mass was set at 50 J (Protection level 2 at “E2” overtest strike energy) and at 0 degree incidence. The engineered P1B knife blade and the NIJ engineered spike were used as the threat weapons.

### INVENTION AND COMPARATIVE EXAMPLES

### KR1

### First Knife Resistant Textile Layer

A single knife resistant textile layer was formed from tape yarns in a 2×2 twill weave with 11 ends/inch and 11 picks/inch. The tape yarns had a size of 1020 denier per yarn, a width of 2.2 mm, and a thickness of 65 μm. The tape yarns had a polypropylene core layer surrounded by two polypropylene copolymer surface layers. The surface layers comprised about 15% by thickness of the total tape yarn. The yarn has a tensile strength of approximately 7 g/d and a tensile modulus of approximately 126 g/d. The fabric layer weighed 100 g/m². This single knife resistant textile layer is designated as KR1 in the following examples.

### SR1

### First Spike Resistant Textile Layer

A KEVLAR® fabric HEXCEL STYLE 726® available from Hexcel Corporation located in Anderson, S.C., was obtained. The Kevlar fabric (Hexcel Style 726) was comprised of KEVLAR 129® 840 denier warp and fill yarns woven together in a plain weave construction with 27 ends/inch and 27 picks/inch. The KEVLAR 129® fiber has a tensile strength of approximately 27 grams per denier (g/d) and an initial tensile modulus of approximately 755 g/d. The textile layer weighed 200 g/m². Next, the textile layer was coating in a bath containing a) approximately 200 grams (or 20%) of CAB-O-SPERSE PG003®, a fumed alumina dispersion (40% solids) with 150 nm particle size available from Cabot Corporation, b) 20 grams (or 2%) MILLITEX RESIN MRX®, a blocked isocyanate based cross-linking agent (35-45% by wt. solids) available from Milliken Chemical, and c) approximately 780 grams of water. The solution was applied using a padding process (dip and squeeze at a roll pressure of 40 psi). The fabric was then dried at 320° F. The dry weight add-on of the chemical on the fabric was approximately 3%. The coated spike resistant textile layer will be designated as SR1 in the following examples.

### Comparative Example 1

Sixty-four (64) layers of KR1 were loosely stacked together with a total areal density of 6.4 kg/m², encased in a nylon bag, and tested for knife resistance.

### Invention Example 2

The KR-1 layer was heat pressed into a single consolidated layer by a compression molding process with 300° F. Platen temperature and 300 psi pressure. The single layer of consolidated KR-1 is designated as KR-1C. Sixty-four (64) layers of KR1-C were loosely stacked together with a total areal density of 6.44 kg/m². The assembly was encased in a nylon bag and tested for knife resistance.

### Invention Example 3

Two layers of KR-1 placed together into a heated press. The two layers were heat pressed into a doublet consolidated layer grouping by a compression molding process with 300° F. Platen temperature and 300 psi pressure. The doublet consolidated layer grouping of KR-1 layers is designated as KR1-2C. Thirty-two (32) layer groupings of KR1-2C were loosely stacked together with a total areal density of 6.44 kg/m². The assembly was encased in a nylon bag and tested for knife resistance.

### Invention Example 4

Thirty-two (32) layer groupings of KR1-1C and Sixteen (16) layers of KR1-2C were loosely stacked together with a total areal density of 6.44 kg/m². The assembly was encased in a nylon bag and tested for knife resistance.

### Comparative Example 5

Thirty-two (32) layers of SR1 were loosely stacked together with a total areal density of 6.4 kg/m², encased in a nylon bag, and tested for knife resistance.

### Comparative Example 6

Twenty one (21) layers of KR1 and twenty one (21) layers of SR1 were loosely stacked in an grouped configuration (all KR1 then all SR2). The resultant stack had a total areal density of 6.44 kg/m². The assembly was encased in a nylon bag and tested for knife resistance.

### Invention Example 7

Twenty one (21) layers of KR1-1C and twenty one (21) layers of SR1 were loosely stacked in an grouped configuration (all KR1-1C then all SR2). The resultant stack had a total areal density of 6.44 kg/m². The assembly was encased in a nylon bag and tested for knife resistance.

The following table shows the stiffness and normalized stiffness for each of the Invention Examples tested according to the Consolidated Layer Groupings Stiffness Test Method described above.

TABLE 1
Stiffness and normalized stiffness of consolidated
layer groupings of Invention Examples

| | Stiffness (g) | Normalized Stiffness (g/g/m²) |
|---|---|---|
| Comp. Ex. 1 | 20 | 0.20 |
| Inv. Ex. 2 | 26 | 0.26 |
| Inv. Ex. 3 | 220 | 1.10 |
| Comp. Ex. 5 | 37 | 0.18 |

TABLE 2
Knife and Spike Penetration test for
Invention and Comparison Examples

| | P1B knife |
|---|---|
| | Penetration (mm) |
| Comp. Ex. 1 | 33 |
| Inv. Ex. 2 | 14 |
| Inv. Ex. 3 | 10 |
| Inv. Ex. 4 | 12.5 |
| Comp. Ex. 5 | 40 |
| Comp. Ex. 6 | 38 |
| Inv. Ex. 7 | 27 |

Comparative Example 1 illustrates that KR1 has relatively poor knife resistance (33 mm of penetration), but that when the single layers are consolidated as in Invention Example 2 (with KR1-1C) the knife resistance increases significantly. The advantage of the consolidation of the KR1 layers is also seen when comparing Comparative Example 7 and Invention Example 8, resulting in a decrease of 29% in penetration of the knife.

When doublets of consolidated layers (KR1-2C) in Invention Example 3 are used the knife penetration increases as compared to the single consolidated layers (Invention Example 2), but the stack is not as flexible (but is still flexible enough to be used in protective garments).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A flexible knife resistant composite comprising a stack of at least five (5) knife resistant textile layers, wherein each knife resistant textile layer comprises monoaxially drawn tape elements, the tape elements comprising a base layer strain oriented olefin polymer with at least one covering layer of a heat fusible olefin polymer on the base layer, wherein the covering layer is characterized by a softening temperature below that of the base layer, wherein the tape elements within each layer are consolidated to one another by the covering layer, and wherein the tape elements of one layer are not consolidated to the tape elements of the adjacent layers.

2. The flexible knife resistant composite of claim 1, wherein the tape elements comprise a base layer strain oriented olefin polymer disposed between two covering layers of a heat fusible olefin polymer.

3. The flexible knife resistant composite of claim 1, wherein the tape elements comprise polypropylene.

4. The flexible knife resistant composite of claim 1, wherein the knife resistant textile layers are woven.

5. The flexible knife resistant composite of claim 1, wherein the layers are attached to one another by a method selected from the group consisting of stitching, patterned adhesive coating, and fastening.

6. The flexible knife resistant composite of claim 1, further comprising at least one consolidated layer grouping, wherein each layer grouping comprises two knife resistant textile layers, wherein each knife resistant textile layer comprises monoaxially drawn tape elements, the tape elements comprising a base layer strain oriented olefin polymer with at least one covering layer of a heat fusible olefin polymer on the base layer, wherein the covering layers are characterized by a softening temperature below that of the base layer, wherein the tape elements within each grouping are consolidated to one another by the covering layer, and wherein the tape elements of the consolidated layer grouping are not consolidated to the tape elements of the knife resistant textile layers.

7. A flexible knife resistant composite comprising a stack of at least three consolidated layer groupings, wherein each layer grouping is consolidated using heat and pressure, wherein each grouping is unconsolidated from the adjacent layer grouping, and wherein each layer grouping comprises:
two knife resistant textile layers, wherein each knife resistant textile layer comprises monoaxially drawn tape elements, the tape elements comprising a base layer strain oriented olefin polymer with at least one covering layer of a heat fusible olefin polymer on the base layer, wherein the covering layers are characterized by a softening temperature below that of the base layer, wherein the tape elements within each grouping are consolidated to one another by the covering layer, and wherein the tape elements of one grouping are not consolidated to the tape elements of the groupings.

8. The flexible knife resistant composite of claim 7, wherein the tape elements comprise a base layer strain oriented olefin polymer disposed between two covering layers of a heat fusible olefin polymer.

9. The flexible knife resistant composite of claim 7, wherein the tape elements comprise polypropylene.

10. The flexible knife resistant composite of claim 7, wherein the knife resistant textile layers are woven.

11. The flexible knife resistant composite of claim 7, further comprising at least one additional knife resistant textile layer, wherein each knife resistant textile layer comprises monoaxially drawn tape elements, the tape elements comprising a base layer strain oriented olefin polymer with at least one covering layer of a heat fusible olefin polymer on the base layer, wherein the covering layer is characterized by a softening temperature below that of the base layer, wherein the tape elements within each layer are consolidated to one another by the covering layer, and wherein the tape elements of the additional knife resistant textile layer are not consolidated to the tape elements of the adjacent knife resistant textile layers or the consolidated layer groupings.

12. A flexible spike and knife resistant composite comprising:
a stack of at least three spike resistant textile layers, wherein the spike resistant textile layers comprise a plurality of interlocking yarns or fibers having a tenacity of about 8 or more grams per denier; and,
a stack of at least three knife resistant layers, wherein the knife resistant textile layers comprise monoaxially drawn tape elements, the tape elements comprising a base layer strain oriented olefin polymer disposed between covering layers of a heat fusible olefin polymer, wherein the covering layers are characterized by a softening temperature below that of the base layer, wherein the tape elements within each layer are consolidated to one another by the covering layer, and wherein the tape elements of one layer are not consolidated to the tape elements of the adjacent layers
wherein the stack of at least three spike resistant textile layers are grouped together in the composite and the stack of at least three knife resistant textile layers are grouped together in the composite.

13. The flexible spike and knife resistant composite of claim 12, wherein the spike resistant and the knife resistant textile layers are woven.

14. The flexible spike and knife resistant composite of claim 12, wherein the spike resistant textile layer has a fabric tightness factor of greater than about 0.75.

15. The flexible spike and knife resistant composite of claim 12, wherein the spike resistant textile layer is impregnated on both sides and at least some of the internal surfaces with about 10 wt. % or less, based on the total weight of the spike resistant textile layer, of a coating comprising a plurality of particles having a diameter of about 20 μm or less.

16. The flexible spike and knife resistant composite of claim 15, wherein the particles are selected from the group consisting of fumed alumina and fumed silica.

17. The flexible spike and knife resistant composite of claim 12, wherein the spike resistant textile layers comprise woven aramid fibers.

18. The flexible spike and knife resistant composite of claim 12, further comprising a flexible ballistic panel.

19. The flexible knife resistant composite of claim 1, further comprising at least one consolidated layer grouping, wherein each layer grouping comprises two knife resistant textile layers, wherein each knife resistant textile layer comprises monoaxially drawn tape elements, the tape elements comprising a base layer strain oriented olefin polymer with at least one covering layer of a heat fusible olefin polymer on the base layer, wherein the covering layers are characterized by a softening temperature below that of the base layer, wherein the tape elements within each grouping are consolidated to one another by the covering layer, and wherein the tape elements of the consolidated layer grouping are not consolidated to the tape elements of the knife resistant textile layers.

20. A flexible knife resistant composite comprising:
a stack of at least three consolidated layer groupings, wherein each layer grouping is consolidated using heat and pressure, wherein each grouping is unconsolidated from the adjacent layer grouping, and wherein each layer grouping comprises two knife resistant textile layers, wherein each knife resistant textile layer comprises monoaxially drawn tape elements, the tape elements comprising a base layer strain oriented olefin polymer with at least one covering layer of a heat fusible olefin polymer on the base layer, wherein the covering layers are characterized by a softening temperature below that of the base layer, wherein the tape elements within each grouping are consolidated to one another by the covering layer, and wherein the tape elements of one grouping are not consolidated to the tape elements of the groupings; and,
a stack of at least three spike resistant textile layers, Wherein the spike resistant textile layers comprise a plurality of interlocking yarns or fibers having a tenacity of about 8 or more grams per denier, wherein the stack of at least three spike resistant textile layers are grouped together in the composite and the stack of at least three knife resistant textile layers are grouped together in the composite.

21. The flexible knife resistant composite of claim 20, further comprising at least one additional knife resistant textile layer, wherein each knife resistant textile layer comprises monoaxially drawn tape elements, the tape elements comprising a base layer strain oriented olefin polymer with at least one covering layer of a heat fusible olefin polymer on the base layer, wherein the covering layer is characterized by a softening temperature below that of the base layer, wherein the tape elements within each layer are consolidated to one another by the covering layer, and wherein the tape elements of the additional knife resistant textile layer are not consolidated to the tape elements of the adjacent knife resistant textile layers or the consolidated layer groupings.

22. The flexible spike and knife resistant composite of claim 20, wherein the spike resistant and the knife resistant textile layers are woven.

23. The flexible spike and knife resistant composite of claim 20, wherein the spike resistant textile layer is impregnated on both sides and at least some of the internal surfaces with about 10 wt. % or less, based on the total weight of the spike resistant textile layer, of a coating comprising a plurality of particles having a diameter of about 20 μm or less.

24. The flexible spike and knife resistant composite of claim 20, further comprising a flexible ballistic panel.

25. The flexible spike and knife resistant composite of claim 20, wherein the spike resistant textile layer has a fabric tightness factor of greater than about 0.75.
